(19) United States
(12) Patent Application Publication
(10) Pub. No.: US 2009/0097054 A1
(43) Pub. Date: Apr. 16, 2009

(54) Method and system for recovering lost printouts

(76) Inventor: Andrew Rodney Ferlitsch, Camas, WA (US)

Correspondence Address: SHARP LABORATORIES OF AMERICA, INC., 1320 PEARL ST., SUITE 228, BOULDER, CO, 80302, US

(21) Appl. No.: 11/974,135

(22) Filed: Oct. 11, 2007

(51) Int. Cl. G06F 3/12

(52) U.S. Cl. 358/1.15

(57) ABSTRACT

A method and system that facilitate recovery of lost printouts in shared print environments. The method and system enable an owner who believes that his or her lost printout may have been inadvertently taken from a shared imaging node to alert other users of the shared imaging node who are most likely to have taken the lost printout. More particularly, the method and system generate and transmit a lost printout alert to users whose printouts were output by the shared printer close in sequence to the lost printout.

### BACKGROUND OF THE INVENTION

The present invention relates to recovery from human error in shared print environments and, more particularly to a method and system that facilitate recovery of a lost printout that may have been inadvertently taken from a shared imaging node.

When an imaging node, such as a multifunction printer (MFP) node, is shared by multiple users, the node's output bin can contain printouts from different users. Occasionally, when a user picks-up his or her printout he or she inadvertently picks-up another user's printout that is, for example, stacked immediately above or below his or hers in the output bin. When the owner of the printout that has been taken by mistake later arrives at the node to retrieve his or her printout he or she is distressed to find it is not there and has no way of knowing who might have taken it. Moreover, by the time the user who mistakenly took the printout becomes aware of the fact and returns it to the output bin, the owner of the printout may have departed, preventing its return to the owner.

### SUMMARY OF THE INVENTION

The present invention, in a basic feature, provides a method and system that facilitate recovery of lost printouts in shared print environments. The method and system enable an owner who believes that his or her lost printout may have been inadvertently taken from a shared imaging node to alert other users of the shared imaging node who are most likely to have taken the lost printout. More particularly, the method and system generate and transmit a lost printout alert to users whose printouts were outputted by the shared printer close in sequence to the lost printout.

In one aspect of the invention, an imaging node comprises a network interface and a processor communicatively coupled with the network interface, wherein under control of the processor in response to a notification from an owner of a lost printout earlier output by the imaging node an alert identifying the lost printout is transmitted via the network interface to at least one user whose printout was earlier output by the imaging node in sequential contiguity with the lost printout.

In some embodiments, the alert is transmitted to the user whose printout was output immediately before the lost printout and the user whose printout was output immediately after the lost printout.

In some embodiments, under control of the processor in response to the notification a selection menu identifying print jobs output by the imaging node is generated using a print history and is presented to the owner.

In some embodiments, under control of the processor information on print jobs is written to the print history attendant to outputting of the print jobs by the imaging node.

In some embodiments, the menu identifies the N latest print jobs output by the imaging node wherein N is at least three.

In some embodiments, the menu identifies the latest print job output by the imaging node that was initiated by the owner.

In some embodiments, under control of the processor in response to a selection by the owner of a print job from the selection menu corresponding to the lost printout the at least one user is identified.

In some embodiments, the alert further identifies a requested action.

In some embodiments, the requested action comprises delivery of the lost printout.

In some embodiments, the requested action comprises a reply to the alert.

In some embodiments, under control of the processor in response to a reply to the alert from at least one user received via the network interface information from the reply is transmitted to the owner.

In some embodiments, the imaging node further comprises a user interface, the notification is received on the user interface and the selection menu is presented on the user interface.

In some embodiments, the notification is received via the network interface and the selection menu is transmitted via the network interface and presented on a node other than the imaging node.

In another aspect, a method for facilitating recovery of a lost printout comprises the steps of receiving a notification of a lost printout, identifying at least one user whose printout was output in sequential contiguity with the lost printout and transmitting to the at least one user an alert identifying the lost printout.

In some embodiments, the method further comprises the steps of presenting a selection menu identifying print jobs output by the imaging node and receiving on the selection menu a selection of a print job corresponding to the lost printout.

In yet another aspect, a method for facilitating recovery of a lost printout comprises the steps of outputting a plurality of print jobs from a plurality of users, storing information on the plurality of print jobs and their respective users, receiving a notification of a lost printout, generating using the stored information a selection menu identifying the plurality of print jobs, receiving on the selection menu a selection of a print job that corresponds to the lost printout, identifying using the stored information at least one user whose printout was output in sequential contiguity with the lost printout and transmitting to the at least one user an alert identifying the lost printout.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a networked imaging system.

FIG. 2 shows an imaging node in some embodiments of the invention.

FIG. 3 shows data processing elements and data flows in a method for facilitating recovery of lost printouts in some embodiments of the invention.

FIG. 4 shows a print job selection menu in some embodiments of the invention.

FIG. 5 is a flow diagram illustrating a method for facilitating recovery of lost printouts in some embodiments of the invention.

### DETAILED DESCRIPTION OF A PREFERRED EMBODIMENT

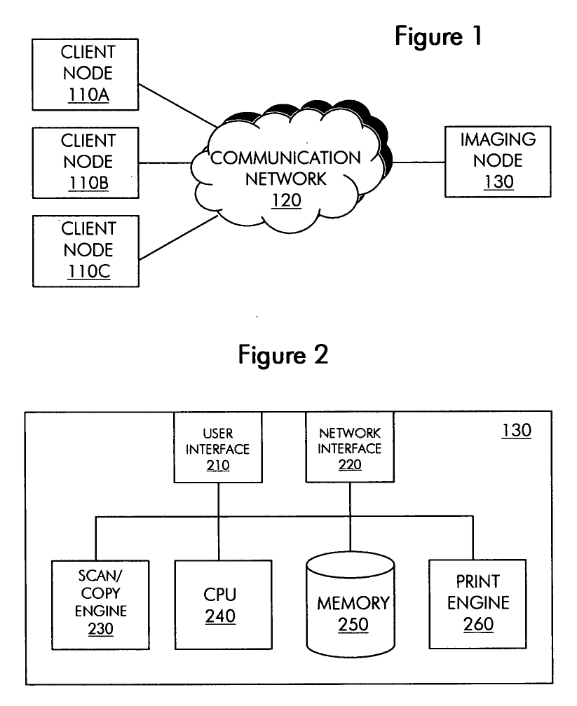

FIG. 1 shows a networked imaging system in which the invention is operative in some embodiments. The system includes a plurality of client nodes 110A, 110B, 110C, such as desktop computers, notebook computers, personal data assistants (PDAs) or cell phones communicatively coupled with a shared imaging node 130 over a communication network 120. Naturally, while three client nodes 110A, 110B, 110C and one imaging node 130 are shown, a system within the scope of the invention may have a different number of client nodes and/or imaging nodes.

Client nodes 110 are data communication devices that have client software allowing users to submit print jobs. Print jobs are submitted by transmitting them via wired or wireless network interfaces of client nodes 110, such as Ethernet, Universal Serial Bus (USB), Bluetooth, Infrared Data Association (IrDa), wireless local area network (LAN) (e.g. Wi-Fi), World Interoperability for Microwave Access (WiMAX), cellular network, or Public Switched Telephone Network (PSTN) interfaces. In some embodiments, network interfaces of client nodes 110 have multiple network ports that support different communication protocols. Print jobs may be sent directly to imaging node 130 or may be first preprocessed within communication network 120 by, for example, a print server node that identifies imaging node 130 as a destination for a print job, converts the print job into an imaging node (IN)-ready format compatible with imaging node 130 and temporarily stores the print job until imaging node 130 becomes available to output the print job.

Communication network 120 is a data communication network that may include one or more wired or wireless LANs, wide area networks (WANs), WiMAX networks, cellular networks, ad-hoc and/or other networks each of which may have one or more data communication nodes, such as switches, routers, bridges and/or hubs, operative to communicatively couple client nodes 110 and imaging node 130. Communication network 120 in some embodiments traverses the Internet.

Turning to FIG. 2, imaging node 130 is shown in more detail. Imaging node 130 is in the illustrated embodiment an MFP node that is shared by client nodes 110 and provides multiple types of imaging services, such as printing, scanning, copying, foxing, filing, displaying, and format conversion. Imaging node 130 has a wired or wireless network interface 220, such as an Ethernet, USB, WAN, Bluetooth, IrDa, WiFi, WiMAX, cellular or PSTN interface that communicatively couples imaging node 130 to communication network 120 and, in some embodiments, to peripheral devices (e.g. USB thumb drive). In some embodiments, network interface 220 has multiple network ports that support different communication protocols. Imaging node 130 also has a user interface 210 for receiving input from walk-up users. Imaging node 130 is capable of receiving via user interface 210 and network interface 220 print jobs in an IN-ready format and processing the print jobs. Received print jobs may contain the content to be printed or a reference to the content to be printed. Internal to imaging node 130, a processor (CPU) 240, a memory 250, user interface 210, network interface 220, a scan/copy engine 230 and a print engine 260 are communicatively coupled. Scan/copy engine 230 includes scanner/copier logic, such as one or more integrated circuits (ICs), and a mechanical section for performing a scanning and copying functions. For example, scan/copy engine 230 may have a line image sensor mounted on a movable carriage for optically scanning a document under the control of a scanner IC and storing the scanned document into memory 250. Print engine 260 includes printer logic, such as one or more printer ICs, and a mechanical section, such as a color ink jet head mounted on a movable carriage, for outputting print data in hard copy format under control of the one or more printer ICs. Memory 250 may consist of one or more random access memories (RAMs) and one or more read only memories (ROM). While imaging node 130 is in the illustrated embodiment an MFP node that supports printing, scanning and copying and other imaging functions, in other embodiments an imaging node may be an MFP node that supports a different set of imaging functions or single-function printer node that supports printing but not other imaging functions.

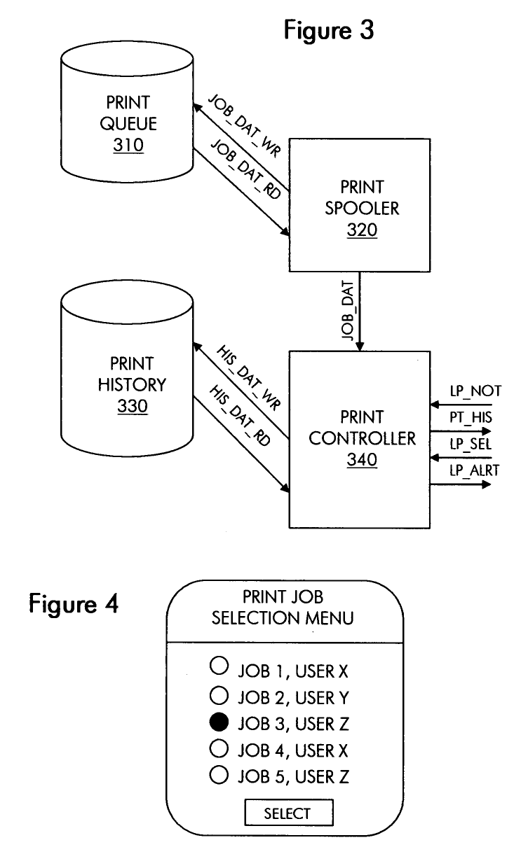

FIG. 3 shows data processing elements and data flows in a method for facilitating recovery of lost printouts in some embodiments of the invention. The data processing elements include a print spooler 320 operatively coupled to a print queue 310 and a print controller 340 operatively coupled between print spooler 320 and a print history 330. In some embodiments, print spooler 320 and print controller 340 comprise software executable by processor 240 and print queue 310 and print history 330 reside in memory 250, although in other embodiments one or more of print spooler 320, print queue 310 and print history 330 may reside outside imaging node 130. For example, in some embodiments, print spooler 320 and print queue 310 reside on a print server node in communication network 120 that intermediates between client nodes 110 and imaging node 130 by, for example, temporarily storing and scheduling print jobs submitted by client nodes 110. By way of example, print queue 310 and print history 330 may be implemented in a system registry, hard drive, non-volatile RAM (NVRAM), database server, storage server, flash, USB thumb drive or smartcard.

In operation, when print spooler 320 receives from one of client nodes 110A, 110B, 110C a print job submitted by a user for outputting by imaging node 130 and there are other print jobs waiting to be serviced by imaging node 130, print spooler 320 spools the print job to print queue 310 (JOB_DAT_WR). In some embodiments, the entire print job is stored in print queue 310 whereas in other embodiments only a print ticket is stored. Once imaging node 130 is able to output the print job, print spooler 320 de-spools the print job from print queue 310 (JOB_DAT_RD) and transmits the print job (JOB_DAT) to print controller 340. Print jobs may be spooled and de-spooled in a predetermined order, such as first-in, first-out (FIFO). Upon receipt, print controller 340 subjects the print job to raster image processing (RIP) to convert the print job into a print engine-ready format and transmits the print engine-ready data to print engine 260 for outputting to an output bin in hard copy format. In some embodiments, imaging node 130 has a single output bin where print jobs are output in sequential order, while in other embodiments an imaging node may have multiple output bins where print jobs are output in sequential order per output bin.

Attendant to outputting the print job, print controller 340 generates a print record of the print job and writes the print record into print history 330 (HIS_DAT_WR). The print record includes information about the print job and the user who submitted it that is gleaned from the print job, as well as an output time indicative of when the print job was output by imaging node 130. More particularly, in addition to the output time, the print record may include user identification information such as a username, user contact information such as an Internet Protocol (IP) address, email address, phone number or fox number, job identification information such as a job name or document name and job detail such as the number of sheets, a thumbnail image of the first page or a stamped identifier (e.g. barcode or watermark). In some embodiments, a separate lookup table may be maintained to resolve user identification information (e.g. username) contained in print records to user contact information (e.g. email address, phone number). The number of print records retained in print history 330 may vary, but is preferably allowed to reach at least three before the oldest print record is purged to make room for a new one.

If the user who submitted the print job thereafter arrives at imaging node 130 and is unable to find the printout of the print job in an output bin, the user initiates a lost printout notification (LP_NOT). In some embodiments, the lost printout notification is initiated through action on user interface 210, such as by depressing a button on a touch screen or dedicated button. In other embodiments, the lost printout notification is initiated through keyboard, keypad or mouse action on one of client nodes 110A, 110B, 110C or a print server node in communication network 120. Where the lost printout notification is initiated remotely from the node that will service it (e.g. imaging node 130), the lost printout notification may be delivered to the servicing node via email, remote procedure call (RPC), Web page interface or Web service interface, for example.

Upon receiving the lost printout notification, print controller 340 retrieves from print history 330 print records for print jobs most recently output by imaging node 130 (HIS_DAT_RD) and presents to the user who submitted the print job whose output has been lost (i.e. the owner of the lost printout) a print job selection menu generated from these print records (PT_HIS). In some embodiments, the print job selection menu is presented on a display of user interface 210, although in other embodiments the print job selection menu may be transmitted via network interface 220 and presented on a display of the one of client nodes 110A, 110B, 110C or a print server node in communication network 120 where the lost printout notification was initiated. In still other embodiments, retrieval of print records from print history 330 and presenting of the print job selection menu may be performed by a data processing element other than print controller 340, such as print spooler 320.

Turning to FIG. 4, an exemplary print job selection menu is shown. In the example shown, the menu lists the five print jobs most recently output (JOB 1, JOB 2, JOB 3, JOB 4, JOB 5) in order of service. Naturally, in other examples more or fewer print jobs may be listed. Each listing identifies a print job and the user who submitted it (USER X, USER Y, USER Z) and has a button allowing the owner of the lost printout to select the print job for which the printout was lost. A print job may be identified in the listing by job identification information (e.g. job name, document name), and the listing may also include job detail (e.g. number of sheets, thumbnail image of first page). The owner may be identified in the listing by user identification information (e.g. username), and the listing may also include user contact information (e.g. email address). At the bottom of the menu is an action button that the owner of the lost printout depresses to convey his or her selections.

In some embodiments, the print job selection menu allows the user to scroll back to earlier-output print jobs and scroll forward to later-output print jobs.

In some embodiments, the print job selection menu only lists print jobs submitted by the owner of the lost printout. In these embodiments, the owner identifies himself or herself to imaging node 130, such as by login or smartcard, before the menu is presented.

Once the owner of the lost printout has selected from the print job selection menu the print job corresponding to the lost printout and conveyed his or her selection (LP_SEL), print controller 340 retrieves from print history 330 user contact information, job identification information and job detail for the selected print job as well as user contact information for at least the print jobs that were output in sequential contiguity with the selected print job, that is, at least the print jobs that were output immediately before and after the selected print job. Sequential contiguity is determined by reference to the output times associated with print records. Print controller 340 generates a lost printout alert (LP_ALRT) using the retrieved user contact information, job identification information and job detail for the selected print job and transmits a lost printout alert to the users who submitted the print jobs that were output in sequential contiguity with the selected print job using the retrieved user contact information for those close in sequence print jobs. The lost printout alert may be transmitted via email, instant message, cellular text message, proprietary Transport Control Protocol over IP (TCP/IP) message, Microsoft asynchronous notification for print jobs, prerecorded phone call or fax, for example. The lost printout alert includes information sufficient to identify the lost printout and its owner. The lost printout is identified by job identification information (e.g. job name, document name) included in the alert, and the alert may also include job detail (e.g. number of sheets, thumbnail image of first page). The owner of the lost printout may be identified in the alert by user identification information (e.g. username), and the alert may also include user contact information (e.g. email address) and may request one or more actions by the alert recipient. Requested actions may include, for example, delivering the lost printout to the owner if the recipient has the lost printout, delivering the lost printout to imaging node 130 if the recipient has the lost printout, replying directly to the owner of the lost printout using the user contact information included in the alert if the recipient has the lost printout, replying directly to the owner of the lost printout using the user contact information included in the alert whether or not the recipient has the lost printout, replying to imaging node 130 if the recipient has the lost printout or replying to imaging node 130 whether or not the recipient has the lost printout. In the case where reply to imaging node 130 is requested, imaging node 130 may upon receipt of one or more such replies generate and transmit a status message to the owner of the lost printout identifying users who have replied and the nature of the reply (e.g. user has or does not have the lost printout). In other embodiments, generation and transmission of a lost printout alert may be performed by a data processing element other than print controller 340, such as print spooler 320.

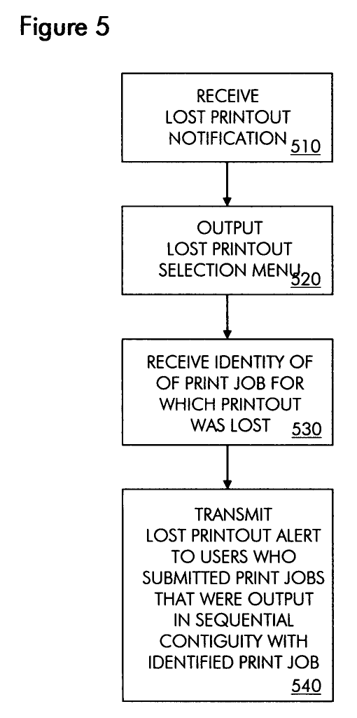

FIG. 5 shows a method for facilitating recovery of lost printouts in some embodiments of the invention. A lost printout notification is received from an owner of a lost printout (510) and in response a print job selection menu generated from print history 330 is presented to the owner (520). The owner identifies from the selection menu the print job for which the printout has been lost (530) and in response a lost printout alert is generated and transmitted to users who submitted print jobs that were output in sequential contiguity with the identified print job (540).

It will be appreciated by those of ordinary skill in the art that the invention can be embodied in other specific forms without departing from the spirit or essential character hereof. For example, the invention is readily applicable to facilitate recovery of other forms of hard copy output, such as faxes and photocopies. The present description is considered in all respects to be illustrative and not restrictive. The scope of the invention is indicated by the appended claims, and all changes that come with in the meaning and range of equivalents thereof are intended to be embraced therein.

What is claimed is:

1. An imaging node, comprising:
a network interface; and
a processor communicatively coupled with the network interface, wherein under control of the processor in response to a notification from an owner of a lost printout earlier output by the imaging node an alert identifying the lost printout is transmitted via the network interface to at least one user whose printout was earlier output by the imaging node in sequential contiguity with the lost printout.

2. The imaging node of claim 1, wherein the alert is transmitted to the user whose printout was output immediately before the lost printout and the user whose printout was output immediately after the lost printout.

3. The imaging node of claim 1, wherein under control of the processor in response to the notification a selection menu identifying print jobs output by the imaging node is generated using a print history and is presented to the owner.

4. The imaging node of claim 3, wherein under control of the processor information on print jobs is written to the print history attendant to outputting of the print jobs by the imaging node.

5. The imaging node of claim 3, wherein the menu identifies the N latest print jobs output by the imaging node wherein N is at least three.

6. The imaging node of claim 3, wherein the menu identifies the latest print job output by the imaging node that was initiated by the owner.

7. The imaging node of claim 3, wherein under control of the processor in response to a selection by the owner of a print job from the selection menu corresponding to the lost printout the at least one user is identified.

8. The imaging node of claim 1, wherein the alert further identifies a requested action.

9. The imaging node of claim 7, wherein the requested action comprises delivery of the lost printout.

10. The imaging node of claim 7, wherein the requested action comprises a reply to the alert.

11. The imaging node of claim 1, wherein under control of the processor in response to a reply to the alert from at least one user received via the network interface information from the reply is transmitted to the owner.

12. The imaging node of claim 1 further comprising a user interface, wherein the notification is received on the user interface and the selection menu is presented on the user interface.

13. The imaging node of claim 1, wherein the notification is received via the network interface and the selection menu is transmitted via the network interface and presented on a node other than the imaging node.

14. A method for facilitating recovery of a lost printout, comprising the steps of:
receiving a notification of a lost printout;
identifying at least one user whose printout was output in sequential contiguity with the lost printout; and
transmitting to the at least one user an alert identifying the lost printout.

15. The method of claim 14, further comprising the steps of:
presenting a selection menu identifying print jobs output by the imaging node; and
receiving on the selection menu a selection of a print job corresponding to the lost printout.

16. The method of claim 14, wherein the alert further identifies a requested action.

17. A method for facilitating recovery of a lost printout, comprising the steps of:
outputting a plurality of print jobs from a plurality of users;
storing information on the plurality of print jobs and their respective users;
receiving a notification of a lost printout;
generating using the stored information a selection menu identifying the plurality of print jobs;
receiving on the selection menu a selection of a print job that corresponds to the lost printout;
identifying using the stored information at least one user whose printout was output in sequential contiguity with the lost printout; and
transmitting to the at least one user an alert identifying the lost printout.

18. The method of claim 17, wherein the alert further identifies a requested action.
